(19) United States
(12) Patent Application Publication
(10) Pub. No.: US 2026/0099844 A1
(43) Pub. Date: Apr. 9, 2026

(54) GENERATIVE ARTIFICIAL INTELLIGENCE ("GenAI") FRAUD DETECTION AND PREVENTION SYSTEM

(71) Applicant: Bank of America Corporation, Charlotte, NC (US)

(72) Inventors: Dasari Samyuktha, Hyderabad Telangana (IN); Sasikumar Purushothaman, Frisco, TX (US); Manu Kurian, Dallas, TX (US)

(21) Appl. No.: 18/907,659

(22) Filed: Oct. 7, 2024

(51) Int. Cl. G06Q 20/40

(52) U.S. Cl. CPC G06Q 20/4016

(57) ABSTRACT

A method for using a GenAI auto prevention and detection system to auto-prevent fraudulent electronic onboarding of a malicious entity purporting to be a new customer is provided. Methods may include receiving an onboarding request from an entity. Methods may also include retrieving the entity's persona. The entity's persona may store data relating to the entity. The entity's persona may be updated each time the entity is involved in a relationship with an institution. The entity's persona may include details relating to the relationship between the entity and the institution. Based on a GenAI model's analysis of the entity's persona, approving or denying the onboarding request.

### FIELD OF TECHNOLOGY

Aspects of the disclosure relate to artificial intelligence.

### BACKGROUND OF THE DISCLOSURE

Typical account onboarding processes may involve a new or existing customer setting up a new account. Such account onboarding processes may not utilize institutional knowledge or general knowledge about the customer when determining whether or not to open the new account. Such account onboarding processes may also not utilize the institutional knowledge or general knowledge about the customer to perform additional diligence into the onboarding customer.

It would be desirable to create a generative artificial intelligence (“GenAI”) fraud detection and prevention system. Such a GenAI fraud detection and prevention system may leverage existing knowledge, from both institutional sources and public sources, to identify anomalous account opening attempts.

### SUMMARY OF THE DISCLOSURE

A GenAI Fraud Detection and Prevention System may be provided. Such a system may also be referred to as a GenAI model. The GenAI model may prevent fraudulent onboarding of a malicious entity pretending to be a new customer. As such, the GenAI model may prevent fraudulent transactions that would have been performed by such a malicious entity.

The GenAI model may stand between an understanding of the possibility of onboarding a potential customer associated with a malicious entity and investigators. It should be understood that investigators may be a computer-generated AI model.

The GenAI model may obtain or collect data for analysis. The obtained data may be geographical-based data. The obtained data may be optical character recognition (“OCR”)-based data.

The obtained or collected data may be fed to the GenAI model. Using the obtained or collected data, the GenAI model may determine/ascertain if an onboarding attempt is a fraudulent onboarding attempt or a valid onboarding attempt. Using the obtained or collected data, the GenAI model may determine/ascertain if a transaction is a fraudulent transaction or a valid transaction. Using the obtained or collected data, the GenAI model may determine/ascertain if a customer is a legitimate customer or a fraudulent/imposter customer.

The GenAI model may create a customer profile based on known information about the customer. An entity may contact the institution. The entity may contact the institution via phone, computer, in-person or through any other communication mode. The GenAI model may determine that an entity contacting the organization is not who they purport to be by comparing the current information and analysis with the customer profile.

The GenAI model according to the disclosure may augment the customer profile with additional customer information. Such additional customer information may be, in certain embodiments, retrieved from other sources, such as third party sources outside the institution, to create a more accurate analysis. Such other sources may include Federal regulatory agencies, databases associated with and storing information corresponding to previous customer interactions, social media sources and any other third party suitable sources. The augmented customer profile may be used to verify the validity and legitimacy of a customer, transaction and/or entity.

The GenAI model may create an onboarding customer profile for a customer seeking a new account. Such an onboarding customer profile may include what is known about the customer from previous accounts with this organization or with other organizations. The GenAI model, using the onboarding customer profile may determine if the customer is above or below a profile threshold. The GenAI model may flag applications associated with onboarding customer profiles that rate above the profile threshold. Flagged applications may be submitted for further investigation prior to account opening. Applications that fall below or within the profile threshold may be allowed to proceed and such customers may be effectively onboarded.

The customer profile may include multiple views and/or facets. As such, a customer's main profile with one company may be identified as a private persona. An additional profile with another company may be referred to as a focused profile. The focused profile may be a public persona. The customer's main profile may be limited to authorized users. However, the focused profile may be easily accessible to unauthorized users. The information included in the private persona and/or the public persona may be obtained from multiple accounts across different financial institutions.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout and in which:

FIG. 1 shows an illustrative diagram in accordance with principles of the disclosure;

FIG. 2 shows another illustrative diagram in accordance with principles of the disclosure;

FIG. 3 shows yet another illustrative diagram in accordance with principles of the disclosure;

FIG. 4 shows still another illustrative diagram in accordance with principles of the disclosure; and

FIG. 5 shows an illustrative flow chart in accordance with principles of the disclosure.

### DETAILED DESCRIPTION OF THE DISCLOSURE

Systems, apparatus and methods for a GenAI fraud detection and prevention system for auto-preventing fraudulent electronic onboarding of a malicious entity purporting to be a new customer is provided.

The system may include a first computing interface. The first computing interface may be operable to communicate with a data network. The data network may include, and/or be available via Early Warning Services®.

The system may include an internal computing interface. The internal computing interface may be operable to communicate with an internal database.

The system may include an internal processor. The internal processor may crawl, via the internal computing interface, the internal database for data relating to historical customers. The internal processor may generate, for each historical customer, a complete profile and a focused profile. The focused profile may mimic focused profiles available via the data network. The focused profiles may include publicly available data for the customer. The internal processor may use the complete profiles in combination with the associated external profiles to automatically tune a large language model. The large language model may effectively limit customer candidates based only on external profiles. The large language model may effectively limit customer candidates based on external profiles.

The system may include a customer-facing interface. The customer-facing interface may operate on the internal processor. The customer-facing interface may receive an electronic onboarding application for a customer.

Upon receipt of the electronic onboarding application, the internal processor may retrieve a focused profile associated with the onboarding application. The internal processor may assign a validation score to the onboarding application by comparing the retrieved focused profile to the onboarding application. The internal processor may reject and store the onboarding application when the validation score is equal to or below a predetermined threshold. The internal processor may push the focused profile through the large language model when the validation score is above the predetermined threshold.

The internal processor may output, from the large language model, a fraud recommendation for the onboarding application. During the processing of the fraud recommendation, the internal processor may consider a comparison between the focused profile associated with the onboarding application and one or more other focused profiles used to train the large language model. During the processing of the fraud recommendation, the internal processor may reveal complete profiles associated with the one or more other focused profiles. The internal processor may generate the fraud recommendation based on the revealed complete profiles. The system may reject one or more applications that include a fraud recommendation greater than a fraud recommendation threshold. The customer-facing interface may display a rejection notification.

A GenAI fraud detection and prevention system for auto-preventing fraudulent electronic onboarding of a malicious entity purporting to be a new customer is provided. The system may include a primary processor. The primary processor may interface between an electronic onboarding system and an AI investigation system. The electronic onboarding system may operate on a first processor. The AI investigation system may operate on a second processor and a large language model.

The primary processor may collect data elements for data analysis. The data elements may relate to a plurality of customers. The data elements may or may not relate to an onboarding customer. The data elements may relate to historical customer onboarding data. The primary processor may feed the collected data elements to a GenAI model. The collecting data elements and/or the feeding the collected data elements to the GenAI model may be performed on a continual basis in order to continually train the GenAI model.

The collected data may be geographical-based data. The collected data may be optical character recognition (“OCR”)-based data.

The primary processor may receive an electronic customer onboarding request communication from a customer. The communication may be transmitted via a communication mode. The communication mode may include email, telephone, chat, web-based, in-person, computer-based or any other suitable communication.

The primary processor may generate, at the GenAI model, a customer profile for the customer. The customer profile may be based on known data relating to the customer. The known data may be stored in a database.

The customer profile associated with a first entity may be identified as a private persona/profile. The customer profile associated with a second company may be identified as a focused profile/public persona.

The primary processor may augment the customer profile with additional customer data. The additional customer data may be retrieved from one or more sources to create a multi-faceted onboarding customer profile. The augmented customer data may be retrieved from agencies, historical customer interactions and social media sources. The augmented customer profile may be used to verify a validity and legitimacy of a customer, transaction and/or entity.

The onboarding customer profile may include what is known about the customer from previous accounts with this organization/institution or with other organizations/institutions.

The primary processor may push the onboarding customer profile through the GenAI model to rank the onboarding customer profile. The primary processor may determine whether the rank of the onboarding customer profile is above or below a profile threshold. The primary processor may flag the request associated with the onboarding customer profile when the onboarding customer profile ranks above the profile threshold. The primary processor may terminate electronic onboarding of the flagged application prior to account opening. The primary processor may electronically approve and onboard the request when the customer profile is below the profile threshold.

A customer's main profile with a primary institution may be identified as a private persona. The customer's main profile may be limited to authorized users. A profile with a secondary institution may be identified as a focused profile. The focused profile may be a public persona. The focused profile may be accessible by unauthorized users.

Illustrative method steps may be combined. For example, an illustrative method may include steps shown in connection with another illustrative method.

The steps of methods may be performed in an order other than the order shown or described herein. Embodiments may omit steps shown or described in connection with illustrative methods. Embodiments may include steps that are neither shown nor described in connection with illustrative methods.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

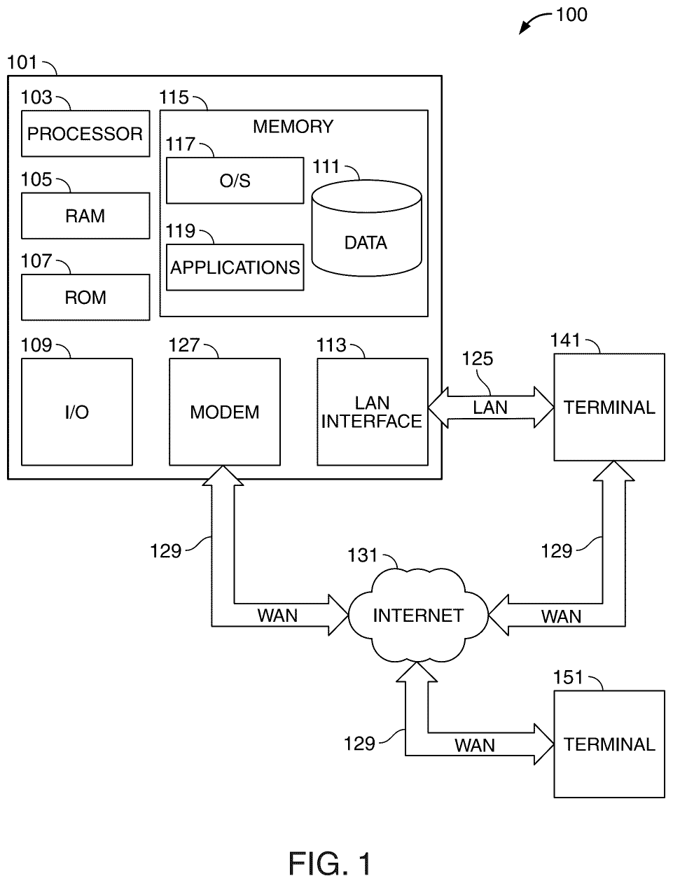

FIG. 1 shows an illustrative block diagram of system 100 that includes computer 101. Computer 101 may alternatively be referred to herein as an “engine,” “server,” or a “computing device.” Computer 101 may be a workstation, desktop, laptop, tablet, smartphone and/or any other suitable computing device. Elements of system 100, including computer 101, may be used to implement various aspects of the systems and methods disclosed herein. Each of the systems, methods and algorithms illustrated below may include some or all of the elements and apparatus of system 100.

Computer 101 may include processor 103 for controlling the operation of the device and its associated components, and may include RAM 105, ROM 107, input/output (“I/O”) 109, and a non-transitory or non-volatile memory 115. Machine-readable memory may be configured to store information in machine-readable data structures. Processor 103 may also execute software running on the computer. Other components commonly used for computers, such as EEPROM or flash memory or any other suitable components, may also be part of computer 101.

Memory 115 may include any suitable permanent storage technology, such as a hard drive. Memory 115 may store software including the operating system 117 and application program(s) 119 along with any data 111 needed for the operation of the system 100. Memory 115 may also store videos, text and/or audio assistance files. The data stored in memory 115 may also be stored in cache memory and/or any other suitable memory.

I/O module 109 may include connectivity to a microphone, keyboard, touch screen, mouse and/or stylus through which input may be provided into computer 101. The input may include input relating to cursor movement. The input/output module may also include one or more speakers for providing audio output and a video display device for providing textual, audio, audiovisual and/or graphical output. The input and output may be related to computer application functionality.

System 100 may be connected to other systems via a local area network (“LAN”) interface 113. System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include LAN 125 and a wide area network (“WAN”) 129 but may also include other networks. When used in a LAN networking environment, computer 101 may connect to LAN 125 through LAN interface 113 or an adapter. When used in a WAN networking environment, computer 101 may include modem 127 or other means for establishing communications over WAN 129, such as Internet 131.

It will be appreciated if the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or application programming interface (“API”). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may include instructions to store the data in cache memory, the hard drive, secondary memory and/or any other suitable memory.

Additionally, application program(s) 119, which may be used by computer 101, may include computer executable instructions for invoking functionality related to communication, such as e-mail, Short Message Service (“SMS”), and voice input and speech recognition applications. Application program(s) 119 (which may be alternatively referred to herein as “plugins,” “applications,” or “apps”) may include computer executable instructions for invoking functionality related to performing various tasks. Application program(s) 119 may utilize one or more algorithms that process received executable instructions, perform power management routines or other suitable tasks.

The invention may be described in the context of computer-executable instructions, such as application(s) 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered for the purposes of this application, as engines with respect to the performance of the particular tasks to which the programs are assigned.

Computer 101 and/or terminals 141 and 151 may also include various other components, such as a battery, speaker and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 141 and/or terminal 151 may be portable devices such as a laptop, cell phone, tablet, smartphone or any other computing system for receiving, storing, transmitting and/or displaying relevant information. Terminal 141 and/or terminal 151 may be one or more user devices. Terminals 141 and 151 may be identical to system 100 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

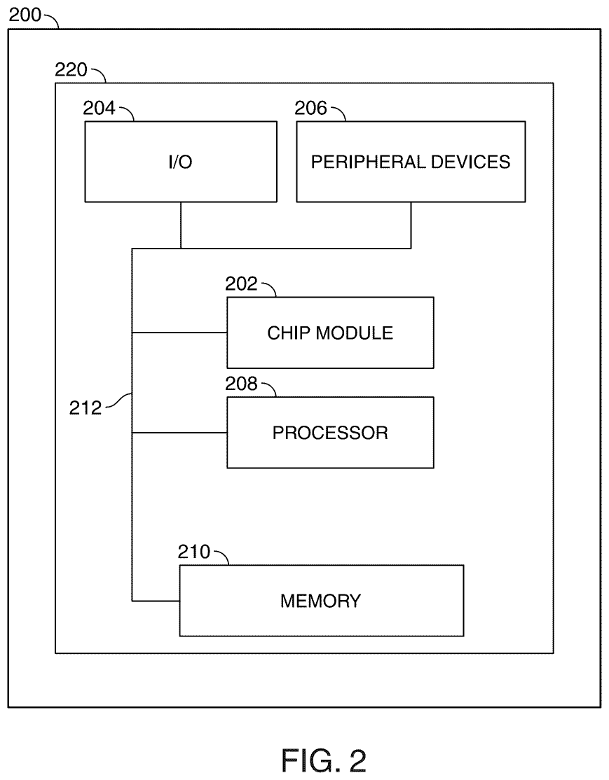

FIG. 2 shows illustrative apparatus 200 that may be configured in accordance with the principles of the disclosure. Apparatus 200 may be a computing device. Apparatus 200 may include one or more features of the apparatus shown in FIG. 1. Apparatus 200 may include chip module 202, which may include one or more integrated circuits, and which may include logic configured to perform any suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 219, signals, and/or any other suitable information or data structures.

Components 202, 204, 206, 208, and 210 may be coupled together by a system bus or other interconnections 212 and may be present on one or more circuit boards such as circuit board 220. In some embodiments, the components may be integrated into a single chip. The chip may be silicon-based.

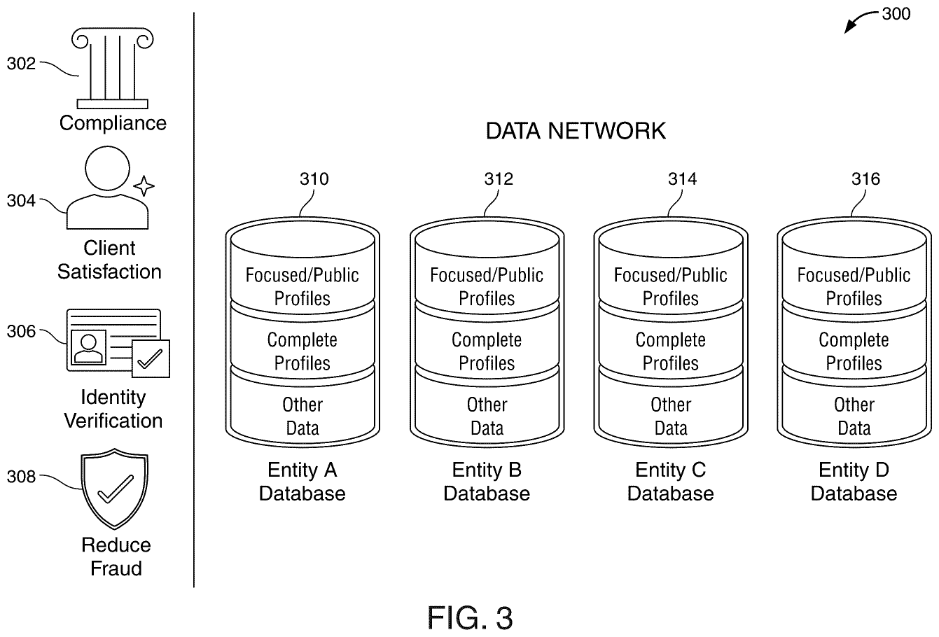

FIG. 3 shows an illustrative diagram 300. Illustrative diagram 300 includes a data network. The data network may include one or more databases. The data network may include entity A database, shown at 310, entity B database, shown at 312, entity C database, shown at 314 and entity D database, shown at 316. In some embodiments, entities A, B, C and D may operate in a similar field or discipline. Each of the databases may include a plurality of tiers. A first tier may correspond to, or store, focused or public profiles. Focused or public profiles may include a name of the customer, an identification number of the customer and other suitable publicly-available identification details. A second tier may correspond to, or store, complete profiles. Complete profiles may include account balance information, account numbers and other suitable restricted information. A third tier may correspond to, or store, other data. Other data may include demographic information, information relating to balance limits, account holds and other suitable information. For example, if a customer went on vacation and informed an entity regarding the vacation, such information may be stored in the other data section.

The data network may be used to ensure entity compliance, as shown at 302. The data network may be used to improve client satisfaction, as shown at 304. The data network may be used verify identities, as shown at 306. The data network may be used to reduce fraud, as shown at 308.

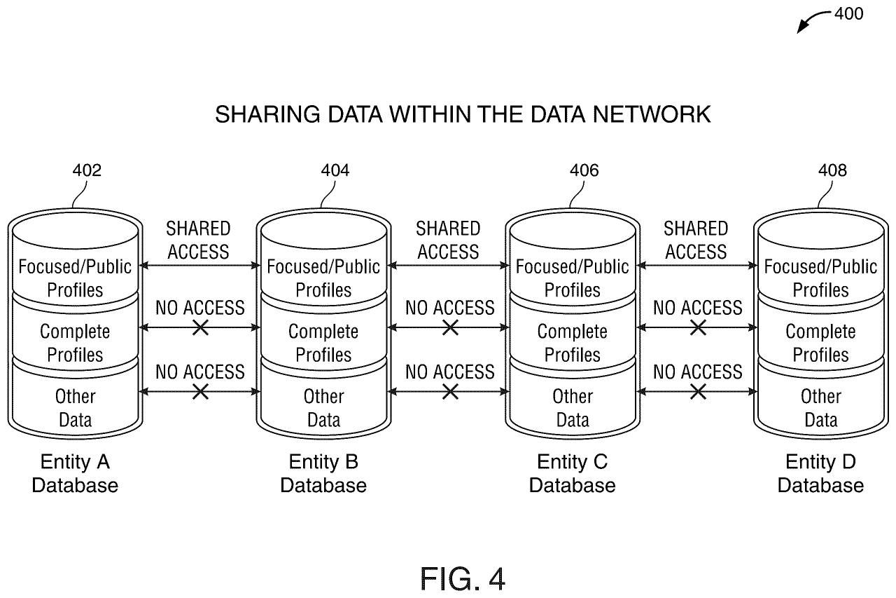

FIG. 4 shows an illustrative diagram 400. Illustrative diagram 400 shows sharing data within the data network. As shown in FIG. 4, focused or public profiles may be shared across entities. As such, focused/public profiles included in entity A database, shown at 402, may be shared with entity B database, shown at 404, entity C database, shown at 406 and entity D database, shown at 408. Focused/public profiles included in entity B database, shown at 404, may be shared with entity A database, shown at 402, entity C database, shown at 406 and entity D database, shown at 408. Focused/public profiles included in entity C database, shown at 406, may be shared with entity A database, shown at 402, entity B database, shown at 404 and entity D database, shown at 408. Focused/public profiles included in entity D database, may be shared with entity A database, shown at 402, entity B database, shown at 404 and entity C database, shown at 406.

However, complete profiles and other information may not be shared across entities. As such, complete profiles and other data included in entity A database, shown at 402, may not be shared with entity B database, entity C database or entity D database. Complete profiles and other data included in entity B database, shown at 404, may not be shared with entity A database, entity C database or entity D database. Complete profiles and other data included in entity C database, shown at 406, may not be shared with entity A database, entity B database or entity D database. Complete profiles and other data included in entity D database, shown at 408, may not be shared with entity A database, entity B database or entity A database.

There may be one or more physical memory barriers within each of databases 402, 404, 406 and 408. The barriers may separate between data which is shareable between entities and data which is not shareable between entities. Data which is shareable between entities may include public data or data which has been authorized to be shared. Data which is not shareable between entities may include private data, personally-identifiable information (“PII”), data which has been determined to be confidential or data which has not been authorized to be shared.

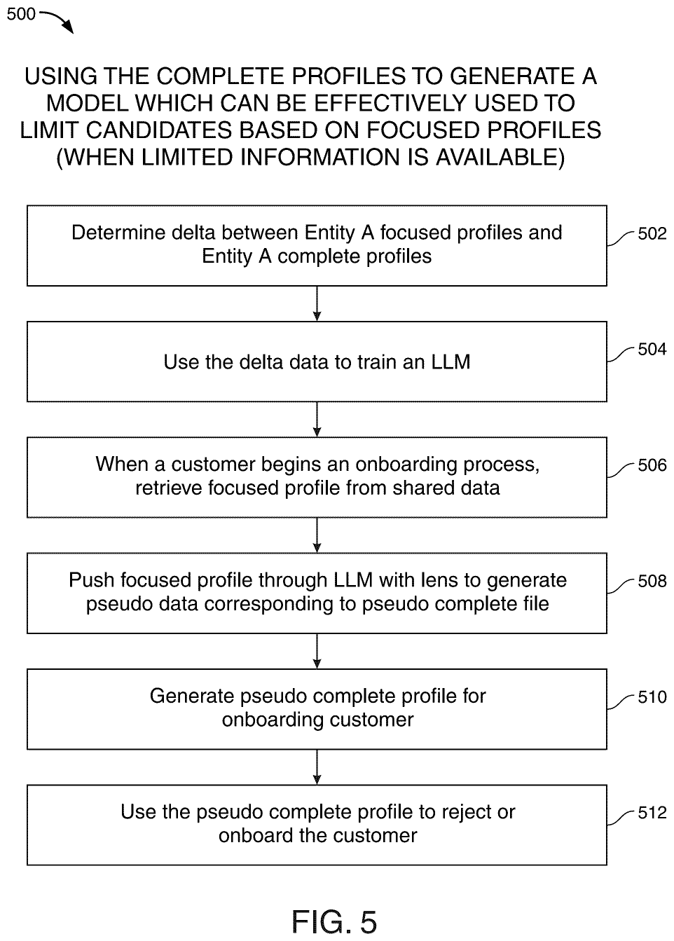

FIG. 5 shows illustrative flow chart 500. Illustrative flow chart 500 shows using the complete profiles to generate a model which can be effectively used to limit candidates based on focused profiles. Step 502 shows determining a delta data set. The delta data set including data relating to the delta between entity A focused profiles and entity A complete profiles. Step 504 shows the training a large language model (“LLM”) with the delta data set. The LLM may also be trained with the complete profile information and the focused profile information. Step 506 shows when a customer initiates an onboarding process, retrieving the focused profile from the shared data. Step 508 shows pushing the focused profile through the LLM with the lens to generate pseudo data corresponding to a pseudo complete profile. Step 510 shows generating a pseudo complete profile. The pseudo complete profiles may be used to auto-onboard the customer. Step 6 shows using the pseudo complete profile to electronically auto-reject or electronically auto-onboard the customer.

Thus, methods and apparatus for a GENERATIVE ARTIFICIAL INTELLIGENCE (“GenAI”) FRAUD DETECTION AND PREVENTION SYSTEM are provided. Persons skilled in the art will appreciate that the present disclosure can be practiced by other than the described embodiments, which are presented for purposes of illustration rather than of limitation and that the present disclosure is limited only by the claims that follow.

1-2. (canceled)

3. A GenAI fraud detection and prevention system for auto-preventing fraudulent electronic onboarding of a malicious entity purporting to be a new customer, the system comprising:
a primary processor operable to:
interface between an electronic onboarding system operating on a first processor and an AI investigation system operating on a second processor and a large language model;
collect data elements for data analysis, said data elements including historical customer onboarding data;
feed the collected data elements to a GenAI model;
receive a customer onboarding request communication from the customer, the communication being transmitted via a communication mode;
generate, at the GenAI model, a customer profile based on known information about the customer;
augment the customer profile with additional customer data retrieved from one or more other sources to create a multi-faceted onboarding customer profile;
rank the onboarding customer profile, at the GenAI model, to determine if the customer is above or below a profile threshold;
flag the request associated with the onboarding customer profile when the rank is above the profile threshold;
terminate electronic onboarding of the flagged application prior to account opening; and
electronically onboarding the request when the rank is equal to or above the profile threshold.

4. The system of claim 3 wherein the customer profile includes multiple views and/or facets.

5. The system of claim 3 wherein the customer profile with a first company is identified as a private persona/profile.

6. The system of claim 3 wherein the customer profile with a second company is identified as a focused profile/public persona.

7. The system of claim 3 wherein the communication mode is telephone or web-based.

8. The system of claim 3 wherein the augmented customer data is retrieved from agencies, historical customer interactions and social media sources.

9. The system of claim 3 wherein the augmented customer profile is used to verify a validity and legitimacy of a customer, transaction and/or entity.

10. The system of claim 3 wherein the collected data is geographical-based data.

11. The system of claim 3 wherein the collected data is optical character recognition (“OCR”)-based data.

12. The system of claim 3 wherein the onboarding customer profile includes what is known about the customer from previous accounts with this organization/institution or with other organizations/institutions.

13. The system of claim 3 wherein a customer's main profile with a primary institution is identified as a private persona.

14. The system of claim 13 wherein the customer's main profile is limited to authorized users.

15. The system of claim 3 wherein a profile with a secondary institution is identified as a focused profile.

16. The system of claim 15 wherein the focused profile is a public persona.

17. The system of claim 15 wherein the focused profile is accessible by unauthorized users.

18. The system of claim 3 wherein information included in a private persona and/or a public persona is obtained from multiple accounts across a plurality of institutions.

19. The system of claim 3, wherein the communication is an onboarding attempt, and the processor is further operable to determine/ascertain if the onboarding attempt is a fraudulent onboarding attempt or a valid onboarding attempt.

20. The system of claim 3, wherein the communication is a transaction attempt, and the processor is further operable to determine/ascertain if the transaction is a fraudulent transaction or a valid transaction.

21. (canceled)
